(19) United States
(12) Patent Application Publication
(10) Pub. No.: US 2006/0060585 A1
(43) Pub. Date: Mar. 23, 2006

(54) Cap structure for a radiator used in vehicle

(76) Inventor: Wan-Yi Liao, Taichung City (TW)

Correspondence Address: LEONG C LEI, PMB # 1008, 1867 YGNACIO VALLEY ROAD, WALNUT CREEK, CA, 94598, US

(21) Appl. No.: 10/945,959

(22) Filed: Sep. 22, 2004

(51) Int. Cl. G01M 3/04; B65D 41/06

(52) U.S. Cl. 220/295; 73/45.8; 73/49.7

(57) ABSTRACT

A cap structure for a radiator used in vehicle is disclosed. The cap includes a main cap body, a connector shaft, and a leak-seal seat. The main cap body includes a metallic cap body and a heat-isolation covering body joined together using screw as a body. The connector shaft is screwed onto the leak-seal seat, and the connector shaft passes through the through hole of a metallic sleeve mounted on the heat-isolation covering body. The side of the protruded rim of the connector shaft urges the end face of the sleeve and a spring is used to mount the connector shaft onto the main cap body. The heat-isolation covering body with a thickness is mounted onto the metallic cap body and two screws are used to lock the metallic cap body onto the heat-isolation covering body to form a unit, and the end side of the covering body is provided with slip-proof teeth and the metallic sleeve is mounted onto the center circular hole.

### BACKGROUND OF THE INVENTION

(a) Technical Field of the Invention

The present invention relates to cap structure, and in particular, to a cap structure for inspection of water pressure leakage within the radiator of a vehicle.

(b) Brief Description of the Prior Art

Taiwanese Utility Model application no. 90217830 entitled “Water Pressure Leakage Inspection Cap Structure” (shown in FIG. 1) discloses a cap structure having a mounting block to increase the contact surface of the screw shaft and a sealing cap, the leakage proof member at the bottom of the screw shaft is effectively mounted to seal the mouth of the radiator to allow accuracy of inspecting water pressure thereof. The drawback of this conventional cap is that while turning the cap, the upper end of the sealing cover is too long, and therefore the exertion of a force is difficult. Further, the surface of the cap is too thin, this makes gripping thereof a problem. The addition of a mounting block causes fabrication process laborious. Accordingly, it is an object of the present invention to provide a cap structure for a radiator used in vehicle which mitigates the drawbacks mentioned above.

### SUMMARY OF THE INVENTION

Accordingly, it is an object of the present invention to provide a cap structure for a radiator used in vehicle comprising a main cap body, a connector shaft, and a leak-seal seat, wherein the main cap includes a metallic cap body and a heat-isolation covering body joined together with screw as a body, and the connector shaft is screwed onto the leak-seal seat, and passes through the through hole of a metallic sleeve mounted on the heat-isolation covering body, and the side of the protruded rim of the connector shaft urges the end face of the sleeve and a spring is used to mount the connector shaft onto the main cap body, characterized in that the heat-isolation covering body with a thickness and with heat-isolation property is mounted onto the metallic cap body and two screws are used to lock the metallic cap body onto the heat-isolation covering body to form an unit, and the end side of the covering body is provided with slip-proof teeth and the metallic sleeve is mounted onto the center circular hole, whereby, the mounting of the metallic cap body with the heat-isolation covering body is enhanced by the metallic sleeve mounted with the connector shaft to the leak-seal seat.

Yet still another object of the present invention is to provide a cap structure for a radiator used in vehicle, wherein the cap body is provided with a gripping face with a larger “hand-gripping surface” facilitating holding by the user.

Yet a further object of the present invention is to provide a cap structure for a radiator used in vehicle, wherein the heat-isolation covering body is installed at the recess at the bottom of the metallic cap body, and the connector shaft at the center of the cap body will not bias and the bottom end of the leak-seal seat seals the mouth of the radiator.

Still another object of the present invention is to provide a cap structure for a radiator used in vehicle, wherein the top end of the connector shaft will not urge the palm of the hand of the user.

Still a further object of the present invention is to provide a cap structure for a radiator used in vehicle, wherein the larger and thicker surface provides better grip so that there will not slip when the cap is rotated.

A further object of the present invention is to provide a cap structure for a radiator used in vehicle, wherein the end face of the metallic cap is covered with a heat-isolation covering body having slip-proof property, the covering body is directly formed with the metallic cap body.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows conventional cap structure of FIG. 3 of Taiwan Utility Model Publication No. 489755.

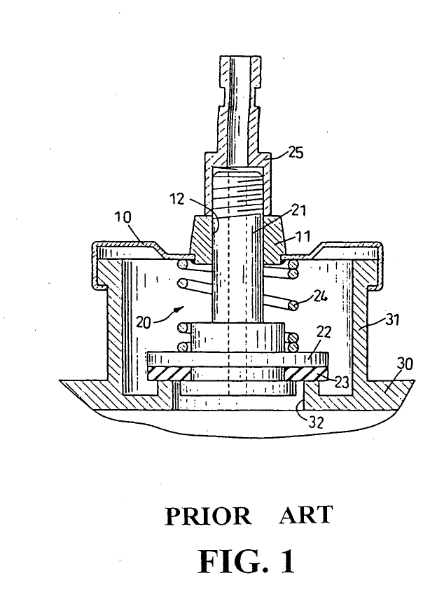

FIG. 2 shows conventional cap structure of FIG. 5 of Taiwan Utility Model Publication No. 489755.

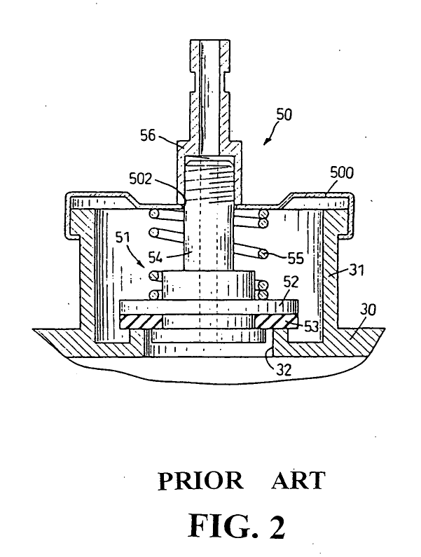

FIG. 3 is a perspective view of the present invention.

FIG. 4 is a perspective exploded view of the present invention.

FIG. 5 is a sectional view of the present invention.

FIG. 6 is a schematic view showing the application of the cap structure of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

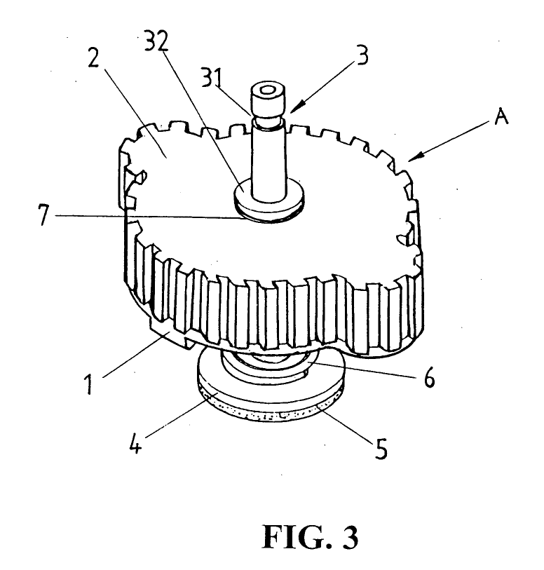

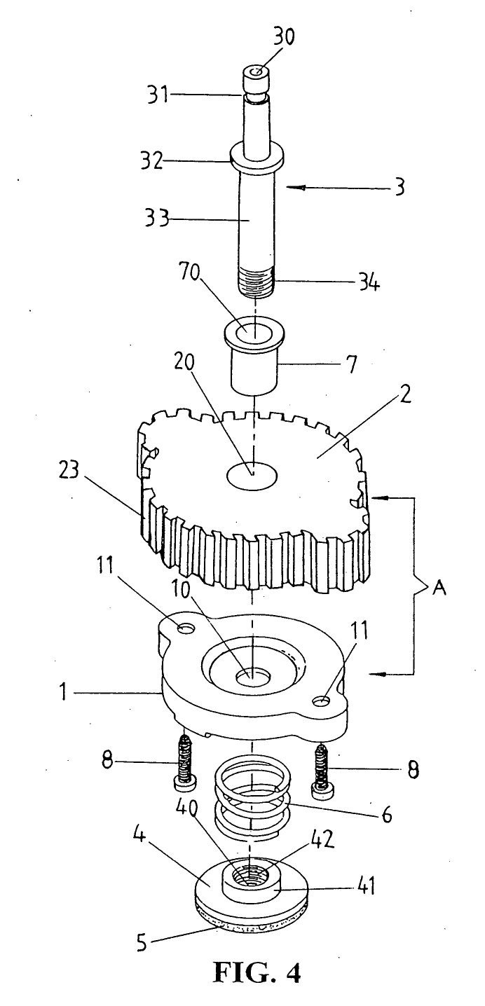

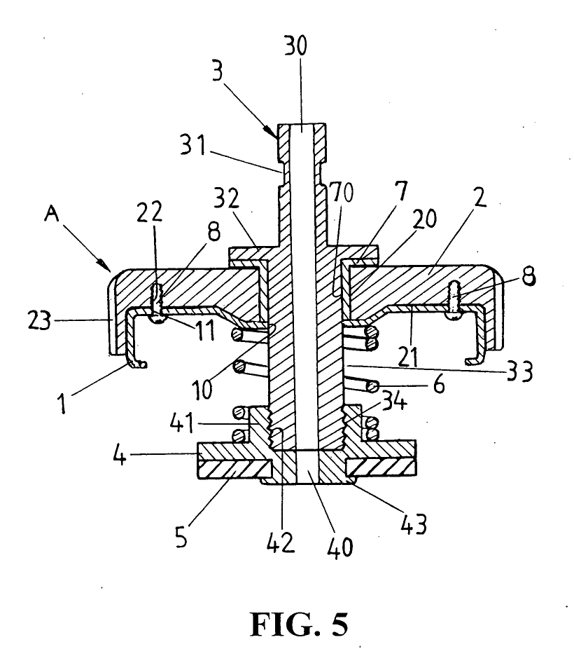

Referring to FIGS. 3, 4, and 5, there is shown a cap structure for a radiator used in vehicle, comprising a main cap body A (including a metallic cap body 1 and a non-metallic heat-isolation covering body 2), a connector shaft 3 and a leak-seal plate 4 and a leak-seal pad 5, a spring 6. The center of the metallic cap body 1 is a circular hole 10, and the surrounding of the circular hole 10 is provided with two pairs of symmetrical holes 11.

The heat-isolation covering body 2 is fabricated into disc shape having a side similar to the recess 21 of the metallic cap body 1. The bottom face of the recess 21 is provided with two screw holes 22 corresponding to the two pairs of the holes 11 of the metallic cap body 1. The center circular hole 20 is mounted with a metallic sleeve 7. Further, the side end face is provided with slip-proof teeth 23.

The shaft center of the connector shaft 3 is a through hole 30 and the upper end of the shaft 3 is a quick connector 31. The bottom end of the shaft 3 is provided with a protruded rim 32 at appropriate diameter. The bottom end diameter 33 is threaded 34 at the lowest end.

The leak-seal plate 4 is a circular disc shape. The upper end of the plate 4 is a protruded seat 41, and the center of the leak-seal plate is a screw hole and two section holes. The center of the upper end of the protruded seat 41 has a screw hole 42, and the screw hole is a through hole 40. The through hole 40 and the through hole 30 of the connector shaft are in communication. Further, the leak-seal pad 5 is mounted at a recessed seat 43 at the bottom end of the leak-seal seat 4 to form as one unit.

In accordance with the present invention, the heat-isolation covering body 2 and the top end of the metallic cap body 1 are first mounted and screws 8 passed through the two pairs of holes 11 and lock at the recess 21 of the covering body 2. The thickness of the heat-isolation covering body 2 and the thickness of the metallic cap body 1 are the same so as to increase the contact surface area of the shaft diameter 33 of the connector shaft 3. After that, the connector shaft 3 is passed through the circular hole of the metallic sleeve 7, the lower end shaft diameter 33 of the connector shaft 3 is exactly the same as the hole diameter of the circular hole 70 of the metallic sleeve 7, and the protruded rim diameter 32 of the connector shaft 3 urges the top face of the center sleeve 7 of the heat-isolation covering body, and the lower end shaft diameter 36 of the connector shaft 3 is inserted with a spring 6. The center screw hole 42 is locked to the external threads 34 at the bottom end of the connector shaft, the spring 6 causes the connector shaft 3 and the leak-seal plate 5 and the leak-seal pad 6 to be urged at the main cap body A to move up and down axially.

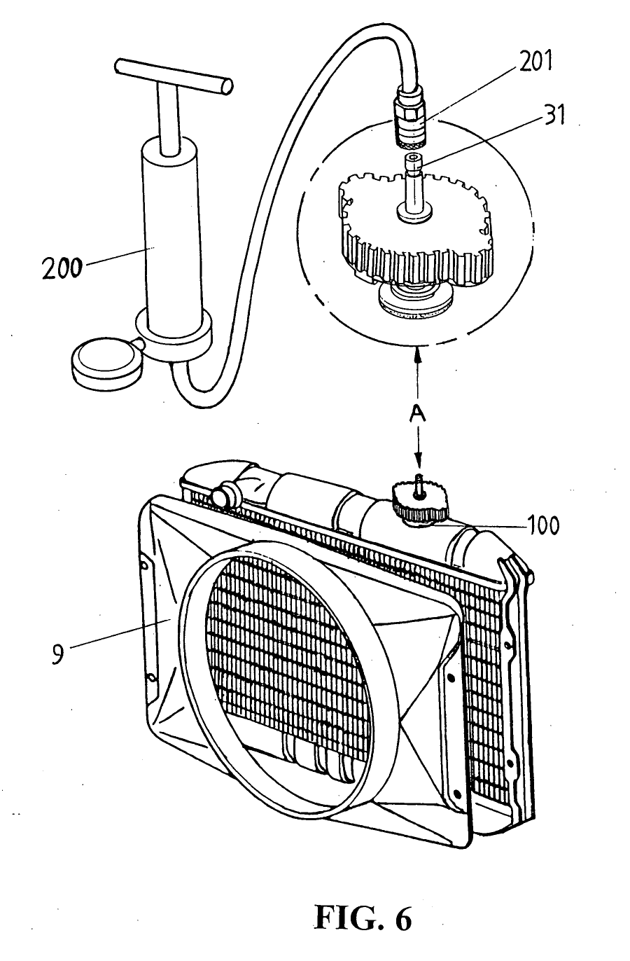

As shown in FIG. 6, the metallic cap body 1 is provided with a heat-isolation covering body 2 of large surface area allowing hand-gripping and the covering body 2 has slip-proof and heat-isolation properties. Thus, when the cap is held and rotated onto the mouth of the radiator, the gripping is strong which ensures tight seal to the mouth of the radiator.

In addition, the center circular hole 70 of the center sleeve 7 allows positioning of the shaft diameter of the connector shaft 3, and the leak-seal pad 6 is urged by the connector shaft 3 and will not move, the sealing of the cap to the mouth of the radiator is effective. Due to the thicker heat-isolation covering A body 2 mounted onto the metallic cap body 1, it can cover one section of the quick connector 31 at the top end of the connector shaft 3 so that the end head exposed out of the connector shaft 3 becomes short. Thus, when the cap body is rotated, the top end of the quick connector 31 will not urge the palm of the user.

There are slip-proof teeth 23 provided at the lateral end of the covering body 2, this will prevent slipping of the gripping of the palm.

Referring to FIG. 6, the main cap body A is mounted onto the mouth 100 of the radiator. To inspect whether there is leakage in water pressure, a pump 200 is connected to the quick connector seat 201 to pump air into the water tank of the radiator. Thus, leakage if any of the tank could be inspected.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cap structure for a radiator used in vehicle comprising a main cap body, a connector shaft, and a leak-seal seat, wherein the main cap includes a metallic cap body and a heat-isolation covering body joined together with screw as a body, and the connector shaft is screwed onto the leak-seal seat, and passes through the through hole of a metallic sleeve mounted on the heat-isolation covering body, and the side of the protruded rim of the connector shaft urges the end face of the sleeve and a spring is used to mount the connector shaft onto the main cap body, characterized in that the heat-isolation covering body with a thickness and with heat-isolation property is mounted onto the metallic cap body and two screws are used to lock the metallic cap body onto the heat-isolation covering body to form an unit, and the end side of the covering body is provided with slip-proof teeth and the metallic sleeve is mounted onto the center circular hole, whereby, the mounting of the metallic cap body with the heat-isolation covering body is enhanced by the metallic sleeve mounted with the connector shaft to the leak-seal seat.
